(19) United States
(12) Patent Application Publication
(10) Pub. No.: US 2025/0333860 A1
(43) Pub. Date: Oct. 30, 2025

(54) ELECTROLYSIS UNIT FOR A FILTER-PRESS-TYPE ELECTROLYSER

(71) Applicant: JOHN COCKERILL HYDROGEN BELGIUM, SERAING (BE)

(72) Inventors: Luc VAN HEE, Oisy le Verger (FR); Sébastien BORGUET, SAINT REMY (BE); Pierre BANASZAK, Vivegnis (BE)

(21) Appl. No.: 18/557,892

(22) PCT Filed: Apr. 25, 2022
(86) PCT No.: PCT/EP2022/060919

§ 371 Date: Apr. 30, 2024

(30) Foreign Application Priority Data
Apr. 30, 2021 (CN) 202110479725.3
Apr. 30, 2021 (CN) 202120941513.8

(51) Int. Cl. C25B 9/73; C25B 9/63

(52) U.S. Cl. CPC C25B 9/73; C25B 9/63

(57) ABSTRACT

Electrolysis unit including a plurality of electrolysis cells held against one another along a stacking axis (Oy) between a first intermediate end plate and a second intermediate end plate, the first end plate including a first smooth bore and the second end plate including a second smooth bore. A tie rod including a body provided, at a first end, with a first head and, at a second end, with a second head, and first tensioning means for tensioning it. An electrolyzer includes the electrolysis unit.

The present invention relates to the field of electrolyzers, and more particularly to the field of “filter press” type electrolyzers constituted by a stack of electrolysis cells. By way of example, such an electrolyzer may be for producing hydrogen.

### BACKGROUND OF THE INVENTION

Conventionally, an electrolyzer comprises a plurality of electrolysis cells extending along a stacking axis one against another between two end plates that are connected together by a plurality of main tie rods. Sealing gaskets are placed between each of the electrolysis cells, and tensioning the main tie rods serves to compress the gaskets so as to provide sealing for the fluid flows of electrolyte and of gas between the electrolysis cells. A large-capacity electrolyzer may comprise several hundreds of electrolysis cells and it is not practical to assemble them one by one on the site where the electrolyzer is to be used. It is thus known to subdivide an electrolyzer into a plurality of electrolysis units that are factory made and each of which comprises a plurality of electrolysis cells. These electrolysis units are then assembled on site, one against another between the end plates, and they are compressed using the main tie rods.

An electrolysis unit is known that includes a first intermediate end plate and a second intermediate end plate between which a plurality of electrolysis cells are compressed using intermediate tie rods. Each intermediate tie rod has a first lug that co-operates with a first notch formed in a first outside face of the first intermediate end plate and a second lug that co-operates with a second notch formed in a second outside face of the first intermediate end plate. Putting such a tie rod into place both requires the alignment of the first and second notches to be checked rigorously since they need to be in alignment on a straight line that is coplanar with the stacking axis, and also requires the lugs to be positioned very accurately in the notches. Otherwise, interfering stresses can appear when the intermediate tie rods are tensioned and can damage the intermediate end plates. Removing the intermediate tie rods after the main tie rods have been tensioned is also difficult, since, while the intermediate tie rods are being released, it frequently happens that the lugs of the tie rods of one electrolysis unit become jammed by the lugs of adjacent electrolysis units. Finally, electrolysis units need to be handled with great prudence, since electrolysis units are generally transported with one of their end plates resting on a horizontal surface (i.e. with the stacking axis extending vertically) but are subsequently assembled in such a manner that the stacking axis is substantially horizontal. All of these difficulties slow down the operations of installing an electrolyzer on site and they penalize the overall cost of supplying an electrolyzer, thereby slowing down the spread of such equipment.

### OBJECT OF THE INVENTION

A particular object of the invention is to improve the cost of supplying an electrolyzer on site.

### SUMMARY OF THE INVENTION

To this end, according invention, there is provided an electrolysis unit comprising a plurality of electrolysis cells held against one another along a stacking axis between a first intermediate end plate and a second intermediate end plate. The first intermediate end plate includes a first smooth bore having a first end opening out along an axis that is substantially orthogonal to the stacking axis, and the second intermediate end plate includes a second smooth bore having an end opening out along an axis that is substantially orthogonal to the stacking axis.

Such a unit can be compressed easily without any risk of interfering stresses appearing or any risk of interference with adjacent units.

On-site wiring operations are greatly reduced when the first intermediate end plate includes a first electrical junction of the anodes of the plurality of electrolysis cells with a first electrical connection port, and when the second intermediate end plate includes a second electrical junction of the cathodes of the plurality of electrolysis cells with a second electrical connection port.

The invention also provides an intermediate tie rod comprising a body provided at a first end with a first head from which a first smooth shaft projects along a first axis. At its second end, the body also includes a second head from which a second smooth shaft projects along a second axis, the intermediate tie rod also including first tensioning means for tensioning it. Such a tie rod serves to limit the appearance of interfering forces while the tie rod is being tensioned, and facilitates on-site assembly of the electrolysis units.

Such a tie rod is particularly inexpensive to make when the tensioning means comprise a tapped bushing engaged with a first threaded portion of the first head and a second threaded portion of the body.

Assembly time can be further reduced when the body includes a first hoist ring and/or when the body includes a notch arranged to receive a hoist cable.

The intermediate tie rod is easily made secure when the first head includes a first drill-hole extending along an axis that is substantially parallel to the first axis.

The invention also provides an electrolyzer comprising at least a first electrolysis unit and a second electrolysis unit as described above that are held against each other along the stacking axis between a first end plate and a second end plate, the first end plate and the second end plate being connected together by at least one main tie rod.

Advantageously, the first electrolysis unit and the second electrolysis unit are electrically connected in series.

Alternatively, the first electrolysis unit and the second electrolysis unit are electrically connected in parallel.

Other characteristics and advantages of the invention appear on reading the following description of a particular and nonlimiting implementation of the invention.

### BRIEF DESCRIPTION OF THE DRAWINGS

Reference is made to the accompanying drawings, in which:

FIG. 1 is a diagrammatic perspective view of an axial section of an electrolysis unit of the invention;

FIG. 2 is a diagrammatic perspective view of a first intermediate plate of the FIG. 1 electrolysis unit;

FIG. 3 is a diagrammatic perspective view of a second intermediate plate of the FIG. 1 electrolysis unit;

FIG. 4 is a diagrammatic perspective view of an intermediate tie rod of the FIG. 1 electrolysis unit;

FIG. 5 is a diagrammatic perspective view of a detail of the FIG. 4 tie rod;

FIG. 6 is a diagrammatic view of a plurality of electrolysis units of the invention;

FIG. 7 is a diagrammatic view of an electrolysis unit in a hoisting situation;

FIG. 8 is a diagrammatic left side view of the FIG. 7 electrolysis unit;

FIG. 9 is a diagrammatic right side view of the FIG. 7 electrolysis unit;

FIG. 10 is a diagrammatic view of an electrolyzer of the invention;

FIG. 11 is a diagrammatic view of electrical wiring for the electrolyzer of the invention.

### DETAILED DESCRIPTION OF THE INVENTION

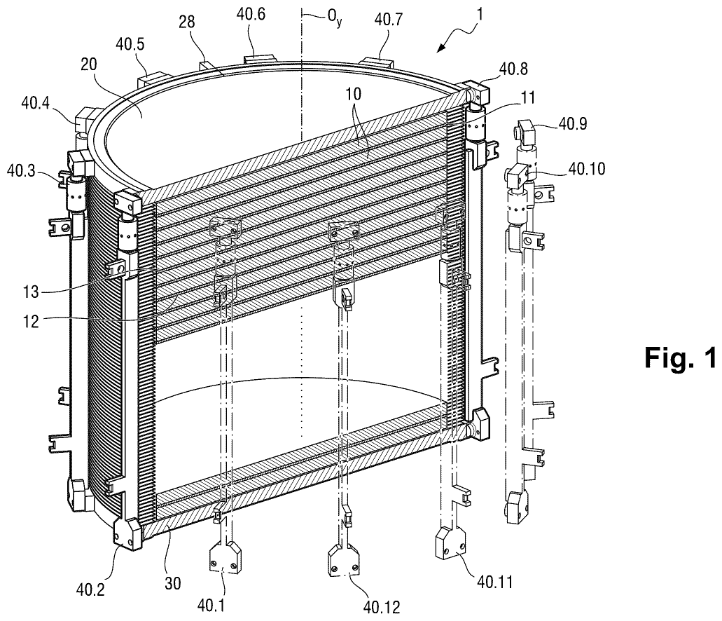

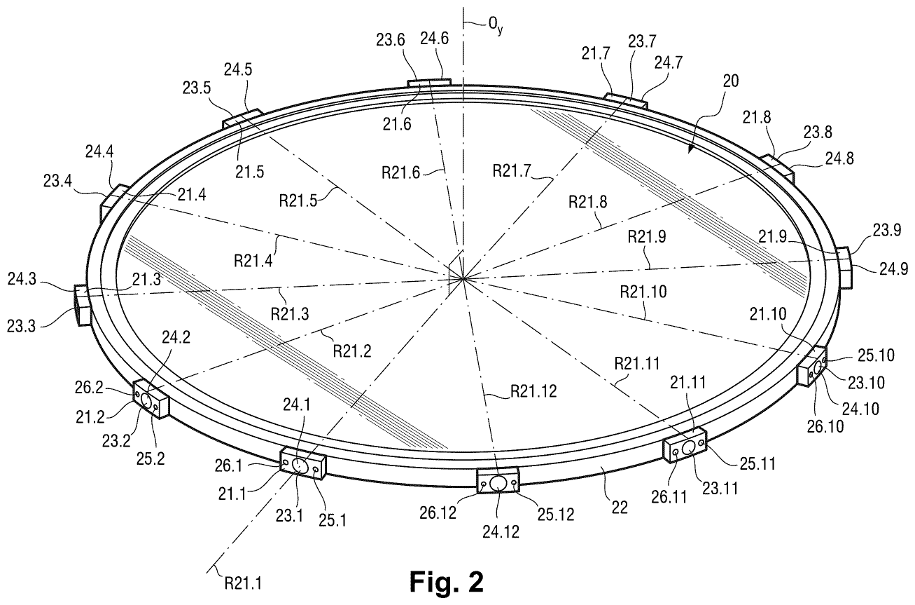

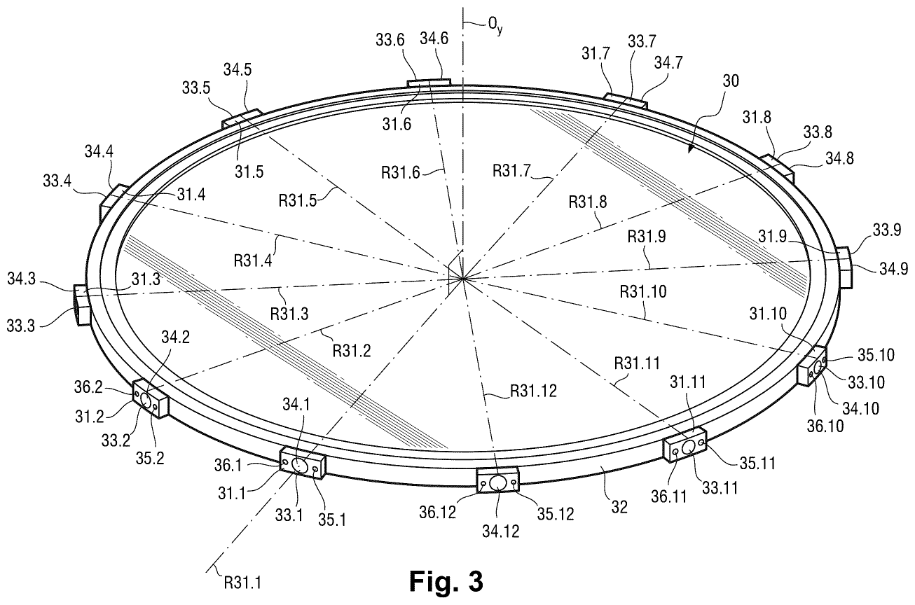

With reference to FIGS. 1 to 5, an electrolyzer unit of the invention, given overall reference 1, comprises a plurality of disk-shaped electrolysis cells 10 extending along a stacking axis Oy. Each electrolysis cell 10 is separated from the next by a gasket 11, which is made of polytetrafluoroethylene in this example. The electrolysis cells 10 are held against one another between a first intermediate end plate 20 and a second intermediate end plate 30, which end plates are identical and are shown in greater detail in FIGS. 2 and 3. The first end plate 20 is disk-shaped and includes twelve first rectangular blocks 21.1 to 21.12 that are welded onto the periphery 22 (referred to as the “first” periphery) of the first intermediate end plate 20. The first block 21.1 has a first smooth bore 23.1 with a first end 24.1 opening out along a first radial axis R21.1 that is substantially orthogonal to the stacking axis Oy. The first block 21.1 also has two tapped holes 25.1 and 26.1 that are positioned on either side of the first smooth bore 23.1.

In identical manner, each of the other first blocks 21.2 to 21.12 has a respective first smooth bore 23.2 to 23.12 with a respective first end 24.2 to 24.12 opening out along a respective first radial axis R21.2 to R21.12 that is substantially orthogonal to the stacking axis Oy, and has two tapped holes 25.2 to 25.12 and 26.2 to 26.12.

In similar manner, the second end plate 30 is disk-shaped and includes twelve second rectangular blocks 31.1 to 31.12 that are welded onto the periphery 32 (referred to as the “second” periphery) of the second intermediate end plate 30. The second block 31.1 has a second smooth bore 33.1 with a second end 34.1 opening out along a second radial axis R31.1 that is substantially orthogonal to the stacking axis Oy. In identical manner, each of the other second blocks 31.2 to 31.12 has a respective second smooth bore 33.2 to 33.12 with a respective second end 34.2 to 34.12 opening out along a respective second radial axis R31.2 to R31.12 that is substantially orthogonal to the stacking axis Oy.

The electrolysis unit 1 has a first electrical connection port 28 constituting an anode and a second electrical connection port 38 constituting a cathode. In conventional manner, the electrolysis unit 1 includes ducts for distributing electrolyte and for collecting the various gases that are generated during electrolysis.

For handling, transporting, and assembling the electrolysis unit 1, the first intermediate plate 20 and the second intermediate plate 30 are connected together by twelve intermediate tie rods 40.1 to 40.12. Since the intermediate tie rods 40.1 to 40.12 are identical, only the first tie rod 40.1 is described.

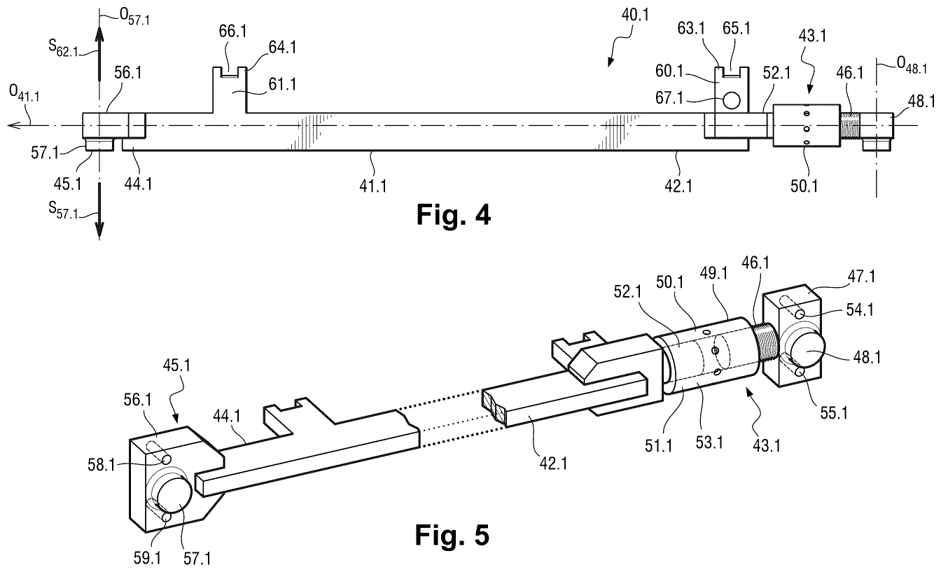

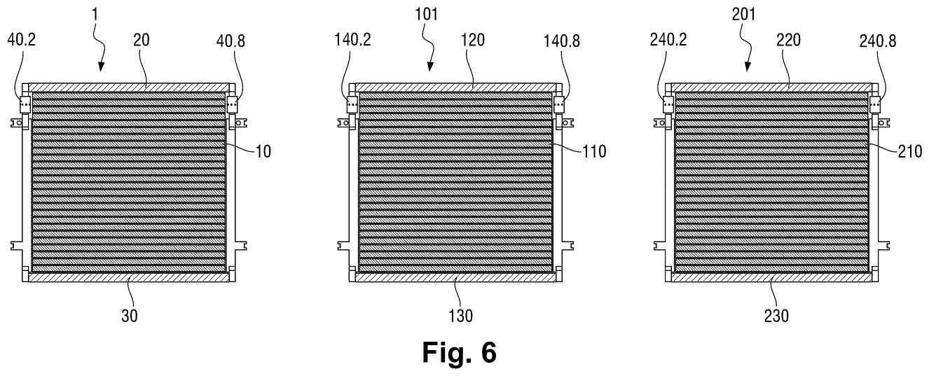

With reference to FIGS. 4 and 5, the first intermediate tie rod 40.1 comprises a body 41.1, specifically in the form of a flat rolled steel bar, that extends along a longitudinal axis O41.1 and that is provided at its first end 42.1 with a first head 43.1 and at its second end 44.1 with a second head 45.1.

The first head 43.1 has a first threaded portion 46.1 with a third rectangular block 47.1 welded thereto. A first smooth shaft 48.1, specifically in the form of a right cylinder, projects from the third block 47.1 along a third axis O48.1 perpendicular to the longitudinal axis O41.1. The first threaded portion 46.1 co-operates with a first end 49.1 of a tapped bushing 50.1. A second end 51.1 of the tapped bushing 50.1 co-operates with a second threaded portion 52.1 of the first end 42.1 of the body 41.1. The tapped bushing 50.1 has two radial drill-holes 53.1 suitable for receiving a tightening pin (not shown). The threads of the first and second threaded portions 46.1 and 52.1 are oppositely handed.

As can be seen in FIG. 5, the third block 47.1 has first and second drill-holes 54.1 and 55.1 that extend along an axis parallel to the third axis O48.1.

The second head 45.1 comprises a fourth rectangular block 56.1 that is identical to the third block 47.1 and that is welded to the body 41.1. A second smooth shaft 57.1, specifically in the form of a right cylinder, projects from the fourth block 56.1 along a first direction S57.1 along a third axis O57.1 perpendicular to the longitudinal axis O41.1. The fourth block 56.1 has third and fourth drill-holes 58.1 and 59.1 that extend along an axis parallel to the third axis O57.1.

As can be seen in FIG. 4, first and second plates 60.1 and 61.1 are welded onto the body 41.1 so as to project from the body 41.1 parallel to the third axis O57.1, but along a second direction S62.1 opposite to the first direction S57.1. The first distal end 63.1 of the first plate 60.1 and the second distal end 64.1 of the second plate 61.1 include respective first and second notches 65.1 and 66.1, which notches are made in this example by flame cutting. The first plate 60.1 also includes a first hoist ring 67.1, made by flame cutting.

Assembly of the electrolysis unit 1 and of the intermediate tie rods 40.1 to 40.12 is described below.

With reference to FIG. 1, one hundred electrolysis cells 10 and one hundred and one gaskets 11 are arranged in alternation on the second intermediate plate 30. The ducts for distributing electrolyte and collecting gas are put into place before the assembly as constructed in this way is covered by the first intermediate plate 20.

The length of the first intermediate tie rod 40.1 is adjusted by means of the bushing 50.1 in such a manner that the first smooth shaft 48.1 and the second smooth shaft 57.1 are spaced apart by a distance that is substantially equal to the distance between the first smooth bore 23.1 of the first intermediate plate 20 and the second smooth bore 33.1 of the second intermediate plate 30. Thereafter the first tie rod 40.1 is presented in such a manner that the first smooth shaft 48.1 and the second smooth shaft 57.1 engage respectively in the first smooth bore 23.1 of the first intermediate plate 20 and the second smooth bore 33.1 of the second intermediate plate 30 so that at least a portion of each of the smooth shafts 48.1 and 57.1 comes to bear against the smooth bores 23.1 and 33.1 respectively. Screws are slid into the first drill-hole 54.1, the second drill-hole 55.1, the third drill-hole 58.1, and the fourth drill-hole 59.1.

The same is done with the intermediate tie rods 40.2 to 40.12.

Using a pin passed through one of the drill-holes 53.1 of the tapped bushing 50.1, the first intermediate tie rod 40.1 is partially tensioned. Using a conventional tension-equalizing scheme, the other intermediate tie rods 40.2 to 40.12 are partially tensioned in the same way.

Steam is injected into the electrolysis cells via the electrolyte distribution duct, and the tie rods 40.1 to 40.12 are tensioned additionally. This causes the gaskets 11 to creep. The operation is repeated several times until satisfactory creep of the gaskets 11 is obtained.

This produces a first electrolysis unit 1 comprising one hundred electrolysis cells 10 compressed between a first intermediate end plate 20 and a second intermediate end plate 30 and held under pressure by the intermediate tie rods 40.1 to 40.12.

Below, for reasons of clarity, elements that are identical or analogous to those described above are given numerical references that are identical to those used above plus 100 or plus 200.

A second electrolysis unit 101 is made in similar manner to making the first electrolysis unit 1 by using one hundred electrolysis cells 110 compressed between a third intermediate end plate 120 and a fourth intermediate end plate 130 and held under pressure by intermediate tie rods 140.1 to 140.12.

A third electrolysis unit 201 is made in similar manner to making the first electrolysis unit 1 by using one hundred electrolysis cells 210 compressed between a fifth intermediate end plate 220 and a sixth intermediate end plate 230 and held under pressure by intermediate tie rods 240.1 to 240.12.

The first electrolysis unit 1 is handled by means of a lifting bridge having a spreader with six legs, each of which is provided with a sling with a free end fitted with a hoist hook. The six hoist hooks are fastened respectively to the hoist rings 67.1, 67.3, 67.5, 67. 7, 67.9, and 67.11 and they enable the first electrolysis unit 1 to be lifted so as to be placed on transport means such as a semitrailer. The second electrolysis unit 101 and the third electrolysis unit 201 are handled in similar manner.

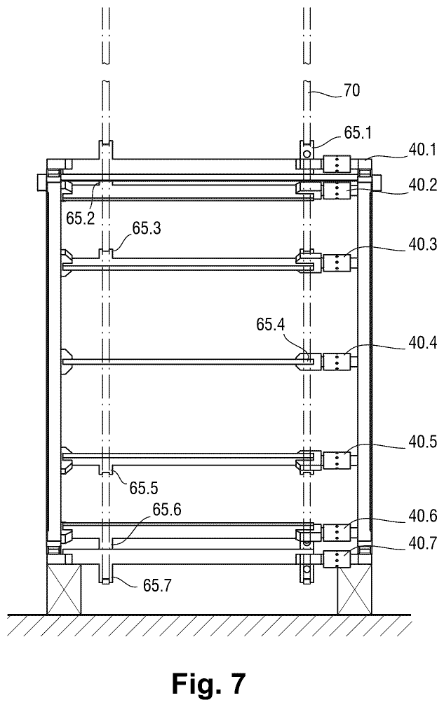

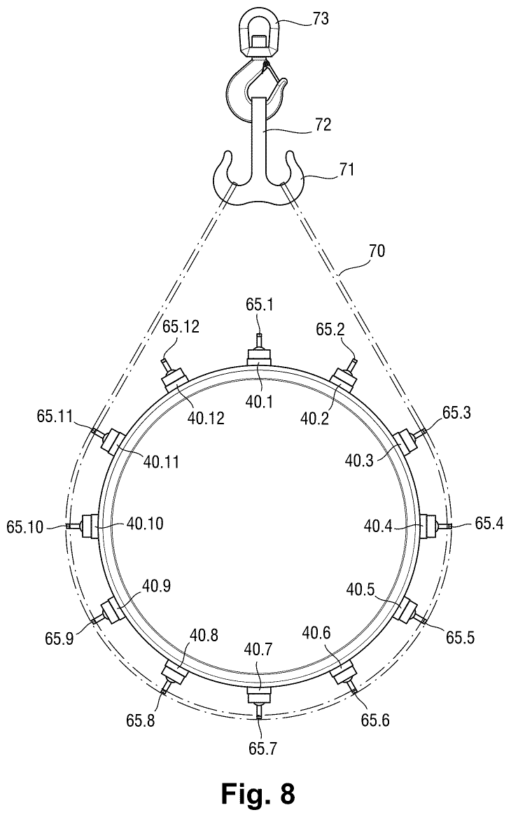

While being installed on site, the first electrolysis unit 1 is tilted into a so-called “horizontal” position so that the stacking axis Oy is substantially horizontal (FIG. 7). This can be done in various ways known to the person skilled in the art. When in its horizontal position, the electrolysis unit 1 is handled by means of a first sling 70 engaged in the first notches 65.3 to 65.11 (FIG. 8) with the two ends of the sling being connected to a first hook 71 of a spreader 72 connected to an overhead travelling crane 73.

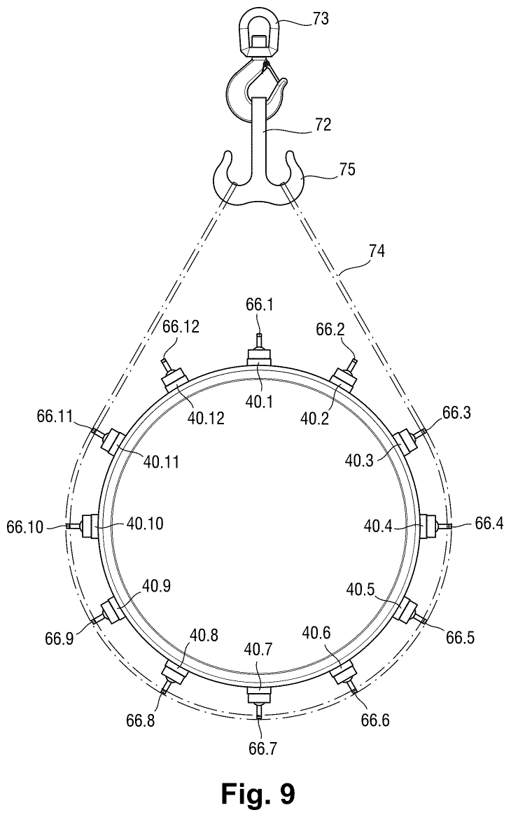

A second sling 74 is engaged in the second notches 66.3 to 66.11 (FIG. 9) with the two ends of the sling being connected to a second hook 75 of the spreader 72.

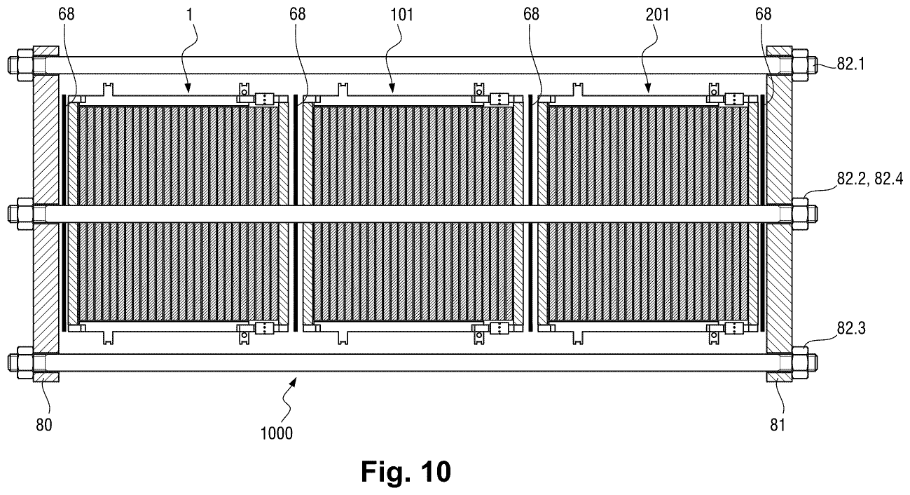

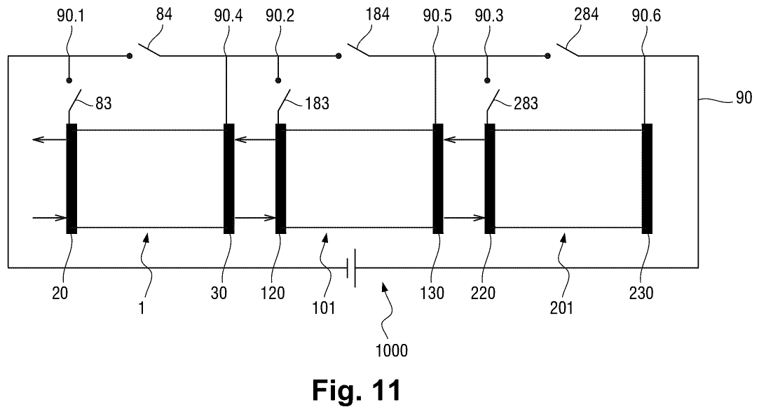

With reference to FIG. 10, the first electrolysis unit 1, the second electrolysis unit 101, and the third electrolysis unit 201 are installed side-by-side between a first end plate 80 and a second end plate 81. Elastomer gaskets 68 are placed at each of the interfaces between a main plate and an intermediate plate and also between the intermediate plates of the electrolysis units 1, 101, and 201. The gaskets 68 provide electrical insulation between the electrolysis units 1, 101, and 201. Four main tie rods 82.1 and 82.4 are placed in bores provided for this purpose the first end plate 80 and in the second end plate 81, and the tie rods are tensioned.

Thereafter, the intermediate tie rods 40.1 to 40.12, 140.1 to 140.12, and 240.1 to 240.12 are removed. By way of example, the intermediate tie rod 40.1 is removed by releasing the tension in the intermediate tie rod 40.1 by acting on the tapped bushing 50.1. The intermediate tie rod 40.1 is removed by being moved in translation along an axis orthogonal to the stacking axis Oy.

Thereafter, the electrolysis units 1, 101, and 201 are connected together electrically. FIG. 11 shows a particularly advantageous way of interconnecting the electrolysis units 1, 101, and 201.

The first, third, and fifth intermediate plates 20, 120, and 220 are respectively connected by means of a first switch 83, a second switch 183, and a third switch 283 to a first point 90.1, to a second point 90.2, and to a third point 90.3 of an electrical power supply circuit 90. The second, fourth, and sixth intermediate plates 30, 130, and 230 are respectively connected electrically to a fourth point 90.4, to a fifth point 90.5, and to a sixth point 90.6 of the electrical circuit 90. A fourth switch 84 connects together the first point 90.1 and the fourth point 90.4. A fifth switch 184 connects together the second point 90.2 and the fifth point 90.5. A sixth switch 284 connects together the third point 90.3 and the sixth point 90.6. Such an arrangement enables one or more electrolysis units to be deactivated, and enables them to be connected in series or in parallel without needing to have recourse to large volumes of cabling that can represent major costs both in terms of raw materials and in terms of installation time.

Once the first electrolysis unit 1, the second electrolysis unit 101, and the third electrolysis unit 201 have been wired together, they constitute an electrolyzer 1000.

In the event of a failure of any one of the electrolysis cells 10, 110, or 210, the electrolyzer 1000 is emptied, and the intermediate tie rods 40.1 to 40.12, 140.1 to 140.12, and 240.1 to 240.12 are put into place and tensioned. The main tie rods 82.1 to 82.4 are then loosened and only the electrolysis unit having the faulty electrolysis cell is extracted. A new electrolysis unit can be put into place quickly and connected to the other electrolysis units so as to enable the electrolyzer 1000 to be restarted quickly.

Naturally, the invention is not limited to the embodiment described, but covers any variant coming within the field of the invention as defined by the claims.

In particular;
although, above, the electrolysis unit has twelve tie rods, the invention applies equally to an electrolysis unit having some other number of tie rods, e.g. such as two, three, four to eleven, are more than twelve;
although, above, the intermediate tie rod has a tapped bushing, the invention applies equally to other means for tensioning the tie rod, e.g. such as a lever, a ratchet wheel, or a pneumatic or hydraulic actuator;
although, above, the hoist ring and the notches are made in plates that are attached to flat surfaces of the bodies of the intermediate tie rods, the invention applies equally to a hoist ring and/or notches that are made directly in the body of a tie rod;
although, above, the smooth shaft is in the shape of a right cylinder, the invention applies equally to smooth shafts of other shapes, e.g. such as a smooth shaft of square or oval section, the shaft is preferably cylindrical in shape;
although, above, all of the electrolysis units have one hundred electrolysis cells, the invention applies equally to electrolysis units having some other number of cells, e.g. such as fifty or more than one hundred, and each of the electrolysis units could have a respective different number of electrolysis cells;
the number of notches through which the sling cable passes depends on the type of slinging and on the distance between the hook and the electrolysis unit that is being handled;
although, above, the electrolyzer has four main tie rods, the invention applies equally to an electrolyzer having some other number of main tie rods, e.g. such as one, two, three, or more than four.

1. An electrolysis unit comprising a plurality of electrolysis cells held against one another along a stacking axis (Oy) between a first intermediate end plate and a second intermediate end plate that are linked together by intermediate tie rods, the first intermediate end plate including a first smooth bore having a first end opening out along an axis that is substantially orthogonal to the stacking axis (Oy), and the second intermediate end plate including a second smooth bore having a second end opening out along an axis that is substantially orthogonal to the stacking axis (Oy), each intermediate tie rod comprising a body provided, at a first end, with a first head from which a first smooth shaft projects along a first axis, the body also being provided, at a second end, with a second head from which a second smooth shaft projects along a second axis, the intermediate tie rod also comprising first tensioning means for tensioning it.

2. An electrolysis unit according to claim 1, wherein the first intermediate end plate includes a first electrical junction of the anodes of the plurality of electrolysis cells with a first electrical connection port, the second intermediate end plate including a second electrical junction of the cathodes of the plurality of electrolysis cells with a second electrical connection port.

3. (canceled)

4. An electrolysis unit according to claim 1, wherein the tensioning means comprise a tapped bushing engaged with a first threaded portion of the first head and a second threaded portion of the body.

5. An electrolysis unit according to claim 1, wherein the body includes a first hoist ring.

6. An electrolysis unit according to claim 1, wherein the body includes a notch arranged to receive a hoist cable.

7. An electrolysis unit according to claim 1, wherein the first head includes a first drill-hole extending along an axis that is substantially parallel to the first axis.

8. An electrolyzer comprising at least a first electrolysis unit and a second electrolysis unit according to claim 1, the electrolysis units being held against each other along the stacking axis (Oy) between a first end plate and a second end plate, the first end plate and the second end plate being connected together by at least one main tie rod.

9. An electrolyzer according to claim 8, wherein the first electrolysis unit and the second electrolysis unit are electrically connected in series.

10. An electrolyzer according to claim 8, wherein the first electrolysis unit and the second electrolysis unit are electrically connected in parallel.
